(19) United States
(12) Patent Application Publication
(10) Pub. No.: US 2023/0229749 A1
(43) Pub. Date: Jul. 20, 2023

(54) COMPUTING DEVICE UNLOCK CODES

(71) Applicant: Hewlett-Packard Development Company, L.P., Spring, TX (US)

(72) Inventors: SUPER LIAO, TAIPEI CITY (TW); HSING-HUNG HSIEH, TAIPEI CITY (TW); ALAN TAM, SPRING, TX (US)

(73) Assignee: Hewlett-Packard Development Company, L.P., Spring, TX (US)

(21) Appl. No.: 18/001,236

(22) PCT Filed: Jul. 10, 2020
(86) PCT No.: PCT/US2020/041509

§ 371 Date: Dec. 8, 2022

(51) Int. Cl. G06F 21/35; G06F 21/36

(52) U.S. Cl. CPC G06F 21/35; G06F 21/36

(57) ABSTRACT

Example implementations relate to computing device unlock codes. In some examples, a computing device can include a locking device, a sensor, a display device including a display area, and a processor to detect an input to the computing device, activate the display device to display an unlock code via the display area, and cause the locking device to disengage in response to an unlock signal being received by the computing device from a remote computing device.

### BACKGROUND

Some users of computing devices may utilize their computing devices in different environments. Certain computing devices can be portable to allow a user to carry or otherwise bring with the computing device while in a mobile setting. A computing device can allow a user to utilize computing device operations for work, education, gaming, multimedia, and/or other general use in a mobile setting.

### BRIEF DESCRIPTION OF THE DRAWINGS

FIG. 1 illustrates a top view of an example of a computing device for computing device unlock codes consistent with the disclosure.

FIG. 2 illustrates a perspective view of an example of a computing device and a remote computing device for computing device unlock codes consistent with the disclosure.

FIG. 3 illustrates a perspective view of an example of a computing device for computing device unlock codes consistent with the disclosure.

FIG. 4 illustrates a block diagram of an example system for computing device unlock codes consistent with the disclosure.

### DETAILED DESCRIPTION

A user may utilize a computing device for various purposes, such as for business and/or recreational use. As used herein, the term “computing device” refers to an electronic system having a processing resource, memory resource, and/or an application-specific integrated circuit (ASIC) that can process information. A computing device can be, for example, a laptop computer, a notebook, a tablet, and/or a mobile device, among other types of computing devices.

When a computing device is utilized in certain settings, security may be a factor. For example, a user may utilize their computing device in a mobile setting such as, for example, at a library, coffee shop, a park, and/or any other mobile setting.

In certain mobile settings, the computing device may be vulnerable to attack and/or compromise. For example, a malicious or otherwise unauthorized user may intend to gain access to the computing device in order to insert malicious software, impersonate the user and/or owner of the computing device, copy personal information and/or files, etc.

Previous approaches to securing a computing device can include software-based security approaches. For example, a user may be presented with a sign-in approach by entering an input to the computing device, such as utilizing the user’s face (e.g., recognized via facial recognition), the user’s finger (e.g., via a finger print reader), and/or input approaches such as input of a personal identification number (PIN), a security key, a username and password, etc., which may be validated by software by comparing the input to known stored values. However, such security approaches may be overcome by the malicious user to gain access to the computing device by tricking facial recognition hardware/fingerprint readers, obtaining user’s PIN/security keys/username and passwords, etc.

Computing device unlock codes according to the disclosure can allow for a locking device to be engaged in order to lock the computing device. Such a locking device may be disengaged after an unlock code, displayed on a display device of the computing device, is input to a remote computing device. The locking device can physically lock the computing device when the lock is engaged, preventing malicious or other unauthorized users from accessing the computing device. Further, malicious or unauthorized users can be prevented from attempting to unlock the locking device as they do not have access to the remote computing device. Accordingly, computing device unlock codes can allow for a safe and secure security mechanism for a computing device for an authorized user when the user is utilizing the computing device in a mobile setting or otherwise as compared with previous approaches.

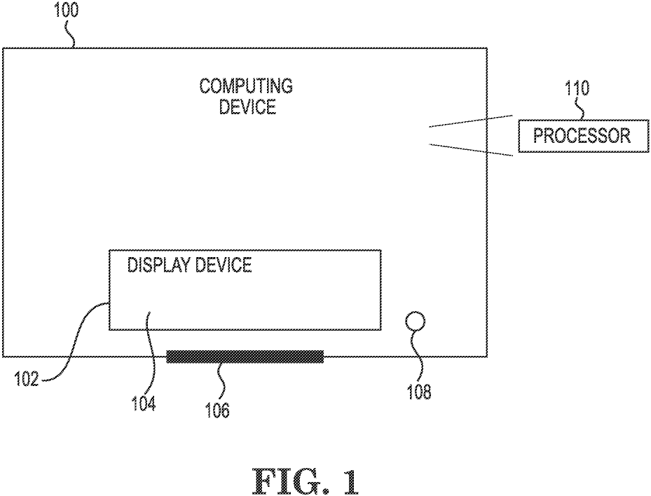

FIG. 1 illustrates a top view of an example of a computing device 100 for computing device unlock codes consistent with the disclosure. As illustrated in FIG. 1, the computing device 100 can include a display device 102, a locking device 106, a sensor 108, and a processor 110.

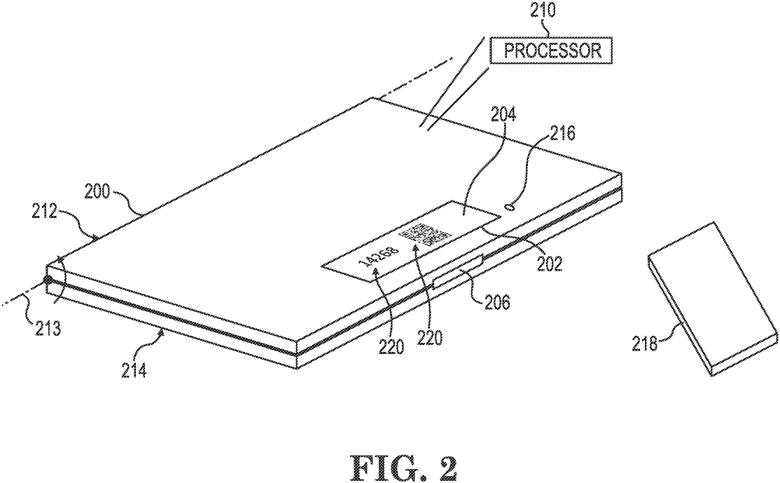

As illustrated in FIG. 1, the computing device 100 can include a locking device 106. As used herein, the term “locking device” refers to a mechanism for securing an object in a particular orientation to prevent motion of the object from the particular orientation. For example, the locking device 106 can secure a first housing and a second housing of the computing device 100 in a closed orientation (e.g., as is further described in connection with FIG. 2).

In some examples, the locking device 106 can be a magnetic locking device. For example, the magnetic locking device can include an electromagnet and an armature plate such that when the electromagnet is energized, a current passing through the electromagnet causes a magnetic flux that causes the armature plate to attract to the electromagnet, creating a locking action to secure the first housing and the second housing of the computing device 100 in the closed orientation.

In some examples, the locking device 106 can be a mechanical locking device. For example, the mechanical locking device can include a bolt such that when a mechanism is actuated, the bolt is propelled into a receiving slot creating a locking action to secure the first housing and the second housing of the computing device 100 in the closed orientation.

Although the locking device 106 is described above as including a magnetic locking device or a mechanical locking device, examples of the disclosure are not so limited. For example, the locking device 106 can be any other type of locking device.

The computing device 100 can include a display device 102. As used herein, the term “display device” refers to an output device that includes a display area that displays information provided by an electrical signal in a visual and/or tactile form. The display device 102 can include a display area 104. As used herein, the term “display area” refers to an area of a display device that displays information. For example, the computing device 100 can include a display device 102 having a display area 104 that can display information such as text, videos, and/or images, as a result of an electrical signal provided to the display from the computing device. As illustrated in FIG. 1, the display device 102 can be located on an exterior surface of the computing device 100, as is further described in connection with FIG. 2. The display area 104 of the display device 102 can display an unlock code in response to an input detected by the sensor 108, as is further described herein.

In some examples, the display device 102 can be an electronic paper (e-paper) display device. As used herein, the term “e-paper display device” refers a display that mimics the appearance of ordinary ink on paper. For example, the e-paper display device can be an electrophoretic display that utilizes charged molecules moving through a fluid or gel under the influence of an electric field to generate an image. Additionally, although the e-paper display device is described above as an electrophoretic display, examples of the disclosure are not so limited. For example, the e-paper display device can be an interferometric modulator, a plasmonic electronic display, and/or any other display technology that mimics the appearance of ink on paper.

Although the display device 102 is described above as being an e-paper display device, examples of the disclosure are not so limited. For example, the display device 102 can be a light emitting diode (LED) display device, liquid crystal display (LCD) display device, segment display device, and/or any other type of display device to display an unlock code, as is further described herein.

The computing device 100 can include a sensor 108. As used herein, the term “sensor” refers to a device to detect events and/or changes in its environment and transmit the detected events and/or changes for processing and/or analysis. For example, the sensor 108 can detect events/changes around the computing device 100, as is further described herein.

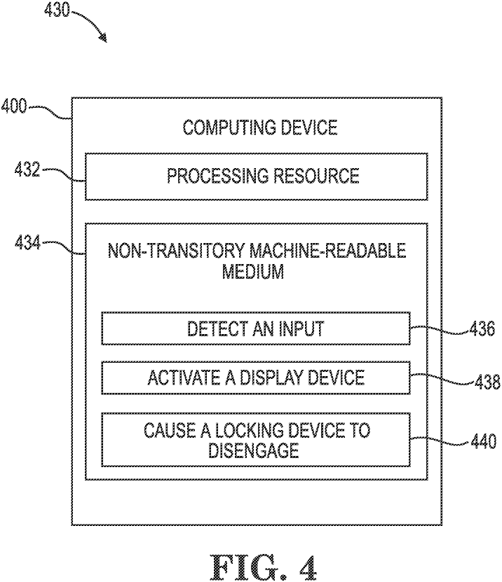

The computing device 100 can include a processor 110. The processor 110 can detect, via the sensor 108, an input to the computing device 100. The input can be based on the type of sensor 108, as is further described herein. In response to the input being detected, the processor 110 can activate the display device 102. The processor 110 can be, for example, processing resource 432, as is further described in connection with FIG. 4.

In some examples, the sensor 108 can be an infrared (IR) sensor. As used herein, the term “IR sensor” refers to a device that measures IR light radiating from an object in its field of view. For example, the IR sensor can detect a user being in proximity to the computing device 100 by measuring IR light radiating from the user. When the user is within a threshold distance of the IR sensor, the IR sensor can detect the presence of the user and transmit a signal to the processor 110 such that the processor 110 can detect the input (e.g., a user being in proximity to the computing device 100). In response, the processor 110 can activate the display device 102.

In some examples, the sensor 108 can be a fingerprint scanner. As used herein, the term “fingerprint scanner” refers to a device that scans a pattern of marks on a finger of a user. For example, a user can provide their finger for scanning by the fingerprint scanner, and the fingerprint scanner can scan the pattern of marks on the finger of the user and compare the scanned pattern of marks to a predetermined pattern of marks. The fingerprint scanner can be an optical scanner, a capacitive scanner, ultrasound scanner, thermal scanner, among other types of fingerprint scanners. When the scanned pattern matches the predetermined pattern, the processor 110 can detect the input (e.g., a user providing their fingerprint to the computing device 100). In response, the processor 110 can activate the display device 102.

In some examples, the sensor 108 can be a camera. As used herein, the term “camera” refers to a device that captures a photographic image or records a video. For example, a user can present their face for scanning by the camera, and the camera can capture a photographic image and/or a video of the user’s face. The processor 110 can compare the captured photographic image and/or video of the user’s face utilizing facial recognition techniques to a predetermined image and/or video of a face. When the scanned face matches the predetermined face, the processor 110 can detect the input (e.g., a user providing their face to the computing device 100). In response, the processor 110 can activate the display device 102.

In some examples, the sensor 108 can be a wireless transceiver. As used herein, the term “wireless transceiver” refers to a device that is able to both transmit and receive information through a transmission medium. For example, the wireless transceiver can, in some instances, transmit information to and/or receive information from a remote computing device (e.g., as is further described in connection with FIG. 2). The wireless transceiver can detect a remote computing device being in proximity to the computing device 100 utilizing radio frequency (RF) signals transmitted to the remote computing device and/or received from the remote computing device. In some examples the wireless transceiver can measure the Time of Flight (ToF) of a signal traveling between the wireless transceiver and the remote computing device and, in response to the ToF being less than a threshold amount, determine the remote computing device is in proximity to the computing device 100 and in response, the processor 110 can activate the display device 102. In some examples the wireless transceiver can measure the Received Signal Strength Indicator (RSSI) of a signal traveling between the wireless transceiver and the remote computing device and, in response to the RSSI exceeding a threshold amount, determine the remote computing device is in proximity to the computing device 100 and in response, the processor 110 can activate the display device 102.

Although the sensor 108 is described above as being an IR sensor, a fingerprint scanner, a camera, and/or a wireless transceiver, examples of the disclosure are not so limited. For example, the sensor 108 can be any other type of sensor.

As described above, the processor 110 can activate the display device 102 in response to the input to the computing device 100 (e.g., detected by the sensor 108). The display device 102 can be activated to display an unlock code via the display area 104. As used herein, the term “unlock code” refers to an arrangement of symbols that, when utilized, cause an event to occur. For example, the display area 104 of the display device 102 can display a matrix barcode, a string of alphanumeric characters, a displayed pattern, or other type of unlock code.

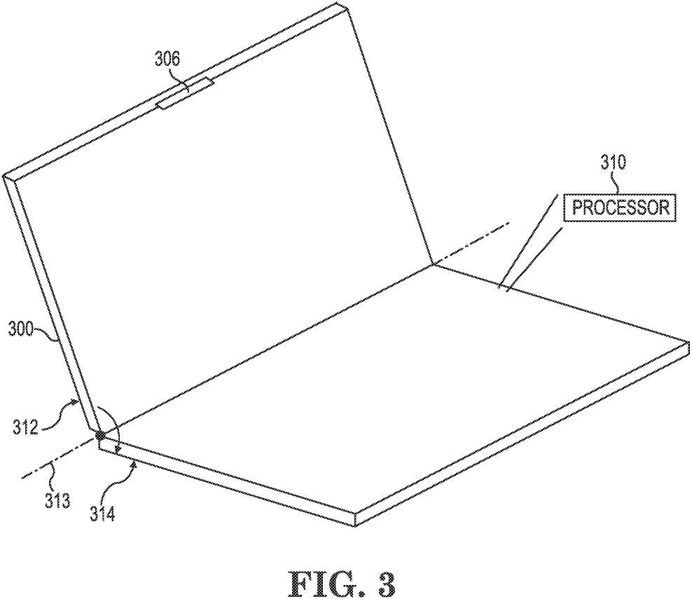

The processor 110 can cause, in response to an unlock signal being received by the computing device 100 from the remote computing device, the locking device 106 to disengage. For example, a user may enter the unlock signal into the remote computing device and in response to the unlock signal being entered, the remote computing device can generate and transmit an unlock signal to the computing device 100. When the computing device 100 receives the unlock signal, the processor 110 can cause the locking device 106 to disengage, allowing the first housing and the second housing of the computing device 100 to be oriented in an open orientation so a user can utilize the computing device 100, as is further described in connection with FIGS. 2 and 3.

FIG. 2 illustrates a perspective view of an example of a computing device and a remote computing device for computing device unlock codes consistent with the disclosure. As illustrated in FIG. 2, the computing device 200 can include a display device 202, a locking device 206, a processor 210, a first housing 212, a second housing 214, and a wireless transceiver 216. The display device 202 can include a display area 204 to display an unlock code 220.

The computing device 200 can include a first housing 212. As used herein, the term “housing” refers to an outer shell of a device. For example, the first housing 212 can be an outer shell making up a portion of the computing device 200. The first housing 212 can include other components of the computing device 200, such as the display device 202, the wireless transceiver 216, a main display device (e.g., not illustrated in FIG. 2), etc.

The computing device 200 can include a second housing 214. The second housing 214 can be an outer shell making up a different portion of the computing device 200 than the first housing 212. The second housing 214 can include other components of the computing device 200, such as input devices (e.g., a keyboard, a touchpad, etc.), hardware components (e.g., motherboard, memory, processor 210, power supply, optical drives, hard drives, etc.), among other components.

The computing device 200 can include the locking device 206. As illustrated in FIG. 2, the locking device 206 can lock the first housing 212 and the second housing 214 in a closed orientation hen the locking device 206 is in a locked position. As used herein, the term “closed orientation” refers to an orientation in which the first housing 212 and the second housing 214 are oriented in a closed clamshell form factor. For example, the first housing 212 and the second housing 214 can be folded relative to each other such that the first housing 212 and the second housing 214 are substantially proximate to each other. As used herein, the term “substantially” intends that the characteristic does not have to be absolute but is close enough so as to achieve the characteristic. For example, “substantially proximate” is not limited to a particular distance apart. For instance, the first housing 212 and the second housing 214 can be within 0.5 mm, 1 mm, 2 mm, 5 mm, etc. apart from each other, among other examples.

The closed orientation of the computing device 200 can allow for the computing device 200 to be securely transported, stored, etc. while the locking device 206 is in the locked position. As used herein, the term “locked position” refers to an orientation of the locking device 206 in which the first housing 212 and the second housing 214 are prevented from being put in motion, securing the first housing 212 and the second housing 214 in the closed orientation. The computing device may be powered off, be put into a hibernation state, etc. such that a user may securely transport the computing device 200 from one location to another, securely store the computing device 200 for later use, etc. while preventing unauthorized users from accessing the computing device 200.

As previously described in connection with FIG. 1, the computing device 200 can include a display device 202. The display device 202 can be located on an external surface of the first housing 212. For instance, the display device 202 can include a display area 204 such that when an authorized user intends to access the computing device 200, the display area 204 can display an unlock code 220 that is viewable to the user, as is further described herein.

As previously described in connection with FIG. 1, the computing device 200 can include a sensor that can be a wireless transceiver 216. For example, the wireless transceiver 216 can detect a remote computing device 218 being in proximity to the computing device 200. As used herein, the term “remote computing device” refers to an electronic system having a processing resource, memory resource, and/or an application-specific integrated circuit (ASIC) that can process information. The remote computing device 218 can be a separate computing device from computing device 200. The remote computing device 218 can be, for example, a laptop computer, a notebook, a tablet, and/or a mobile device, among other types of computing devices. As used herein, a mobile device can include devices that are (or can be) carried and/or worn by a user. For example, a mobile device can be a phone (e.g., a smart phone), a tablet, a personal digital assistant (PDA), smart glasses, and/or a wrist-worn device (e.g., a smart watch), among other types of mobile devices.

For example, a user of the computing device 200 may additionally carry the remote computing device 218, which may be, for instance, a mobile phone or other type of computing device. The user can utilize the remote computing device 218 to cause the locking device 206 to be disengaged, as is further described herein.

The wireless transceiver 216 can detect a remote computing device 218. For example, the wireless transceiver 216 can detect whether the remote computing device 218 is within a threshold distance to the computing device 200, as is further described herein.

In some examples, the wireless transceiver 216 can detect the remote computing device 218 using ToF of a signal traveling between the wireless transceiver 216 and the remote computing device 218. As used herein, the term “ToF” refers to a measurement of an amount of time taken by a signal to travel a distance through a medium. For example, a signal transmitted by the wireless transceiver 216 to the remote computing device 218 can have a corresponding ToF. In response to the ToF of a signal between the wireless transceiver 216 and the remote computing device 218 being less than a threshold amount, the processor 210 can determine the remote computing device is within a threshold distance to the computing device 200.

In some examples, the wireless transceiver 216 can detect the remote computing device 218 using an RSSI of a signal received from the remote computing device 218. As used herein, the term “RSSI” refers to an measurement of an amount of power present in a received radio frequency signal. For example, a signal transmitted by the remote computing device 218 to the wireless transceiver 216 can include a corresponding RSSI. In response to the RSSI of a signal between the remote computing device 218 and the wireless transceiver 216 being greater than a threshold amount, the processor 210 can determine the remote computing device is within a threshold distance to the computing device 200.

As described above, the processor 210 can detect when the remote computing device 218 is within a threshold distance to the computing device 200. In response to the remote computing device 218 being within the threshold distance to the computing device 200, the processor 210 can activate the display device 202 to display an unlock code 220 via the display area 204.

In some examples, the remote computing device 218 can be connected to the computing device 200 via a wired or wireless connection. In such an example, the remote computing device 218 can transmit a device identifier to the computing device 200. The device identifier can be, for example, a media access control (MAC) address of the remote computing device 218. In addition to determining the remote computing device 218 is within a threshold distance to the computing device 200, the computing device 200 can compare the MAC address of the remote computing device 218 to a stored MAC address to validate the identity of the remote computing device 218. Accordingly, in response to the remote computing device 218 being within the threshold distance to the computing device 200 and the identity of the remote computing device 218 being validated via the device identifier associated with the remote computing device 218, the processor 210 can cause the display device 202 to display an unlock code 220 via the display area 204. Such an approach may provide an additional layer of security to control access to the computing device 200.

Although a wireless transceiver 216 is described above as detecting when a remote computing device 218 is within a threshold distance to the computing device 200, examples of the disclosure are not so limited. For example, as previously described in connection with FIG. 1, the computing device 200 can include a different type of sensor from a wireless transceiver 216, such as an IR sensor, a fingerprint scanner, and/or a camera that can detect the presence of a user being proximate to the computing device 200. In such examples, the IR sensor, the fingerprint scanner, and/or the camera can be utilized to determine the presence of a user and cause, in response, the unlock code 220 to be displayed via the display area 204 of the display device 202.

In some examples, the display area 204 can display an unlock code 220 consisting of a string of alphanumeric characters. For example, as illustrated in FIG. 2, the unlock code 220 can be a five-character string consisting of the numbers “14268”. However, examples of the disclosure are not so limited to a five-character string of all numbers. For example, the string of alphanumeric characters can be longer or shorter than five characters and can include a combination of letters, numbers, and/or other symbols.

In some examples, the display area 204 can display an unlock code 220 consisting of a matrix barcode. As used herein, the term “matrix barcode” refers to an organization of symbols to represent data in a visual, machine-readable form. For example, as illustrated in FIG. 2, the unlock code 220 can be a matrix two-dimensional (2D) barcode, such as a QR code. However, examples of the disclosure are not limited to a QR code. For example, the unlock code 220 can be any other type of matrix 2D bar code (e.g., an AR code, an Aztec code, a Data Matrix, an EZcode, etc.). Alternatively, the unlock code can be a linear barcode such as a Universal Product Code (UPC) or any other type of linear barcode.

In some examples, the display area 204 can display an unlock code 220 consisting of a displayed pattern (e.g., not illustrated in FIG. 2). For example, the displayed pattern may be a series of columns and rows of dots having a line connecting certain dots in the series of columns and rows. However, examples of the disclosure are not so limited. For example, the displayed pattern can be any other type of pattern.

The displayed unlock code 220 can be input to the remote computing device 218. For example, the series of alphanumeric characters (e.g., “14268”) may be entered by a user into the remote computing device 218. As another example, the user may utilize a camera of the remote computing device 218 to capture the QR code in order to input the displayed unlock code 220.

Successful input of the unlock code 220 into the remote computing device 218 can cause the remote computing device 218 to generate an unlock signal. As used herein, the term “unlock signal” refers to a signal representing information to cause an event to occur. For example, the remote computing device 218 can generate the unlock signal representing information to cause the locking device 206 to disengage. The remote computing device 218 can transmit the unlock signal to the computing device 200.

In some examples, the unlock code 220 may be displayed for a predetermined amount of time. For example, the unlock code 220 may be displayed via the display area 204 of the display device 202 for thirty seconds. The processor 210 can change the displayed unlock code in response to the unlock signal not being received by the computing device 200 after the predetermined amount of time. For example, if a user does not enter the alphanumeric string of characters (e.g., “14268”) into the remote computing device 218 within the thirty second amount of time, the processor 210 can change the displayed unlock code to a different string of alphanumeric characters (e.g., “43562”) or to a different type of unlock code (e.g., a displayed pattern, a QR code, etc.).

The processor 210 can cause the locking device 206 to disengage from the locked position to an unlocked position in response to the unlock signal being received by the computing device 200 from the remote computing device 218. As used herein, the term “unlocked position” refers to an orientation of the locking device 206 in which the first housing 212 and the second housing 214 are free to be put in motion so that the first housing 212 and the second housing 214 can be oriented in an open orientation. As used herein, the term “open orientation” refers to an orientation in which the first housing 212 and the second housing 214 are oriented in an open clamshell form factor. For example, the first housing 212 and the second housing 214 can be foldable relative to each other via a rotation axis 213. For example, the processor 210 can cause the locking device 206 to disengage so that a user can rotate the first housing 212 (e.g., as indicated in FIG. 2) away from the second housing 214 about the rotation axis 213 in order to access the computing device 200.

The unlock signal generated by the remote computing device 218 can include a hash. As used herein, the term “hash” refers to a set of encoded data. The hash can include data which can be utilized by the processor 210 to determine whether to disengage the locking device 206. In response to the unlock code being entered into the remote computing device 218, the remote computing device 218 can generate the hash.

As described above, the remote computing device 218 can transmit the unlock signal (which includes the generated hash) to the computing device 200. The processor 210 can compare the hash included in the unlock signal to a hash table stored in a database. As used herein, the term “hash table” refers to a data structure that can map keys to values. The database including the hash table can be local to the computing device 200 (e.g., stored locally in memory included in the computing device 200) or remote from the computing device 200 (e.g., stored in a remote server or other computing device, accessible via a network relationship).

The processor 210 can compare the has received from the remote computing device 218 to the hash table. In response to the hash received from the remote computing device 218 matching a hash included in the hash table, the processor 210 can cause the locking device 206 to disengage. For example, the hash included in the unlock signal generated by the remote computing device 218 can include information to validate the identity of the remote computing device 218 to the computing device 200, and the processor 210 can validate the identity of the remote computing device 218 by comparing the hash to the hash table. In response to the hash received from the remote computing device 218 not matching a hash included in the hash table, the processor 210 can prevent the locking device 206 from disengaging.

In response to the locking device 206 being disengaged, the first housing 212 is movable relative to the second housing 214. For example, a user can rotate the first housing 212 about the rotation axis 213 relative to the second housing 214 to an open orientation to allow the user to operate the computing device 200.

In some examples, the remote computing device 218 can correspond to a user profile of the computing device 200. As used herein, the term “user profile” refers to a virtual environment including characteristics associated with a user identity. The user profile can include settings, customized characteristics, and/or other data corresponding to a particular user identity. For example, a first user having remote computing device 218 can enter an unlock code and the remote computing device 218 can transmit an unlock signal to the computing device 200. In response, the computing device 200 can log in to the user profile associated with the first user based on the unlock signal being received from the remote computing device 218. A second user having a different remote computing device (e.g., not illustrated in FIG. 2) who may also be authorized to utilize the computing device 200 may enter an unlock code (e.g., when the first housing 212 and the second housing 214 are in the closed orientation and the locking device 206 is in the locked position) and the different remote computing device can transmit an unlock signal to the computing device 200. In response, the computing device 200 can log in to the user profile associated with the second user based on the unlock signal being received from the other remote computing device.

FIG. 3 illustrates a perspective view of an example of a computing device 300 for computing device unlock codes consistent with the disclosure. As illustrated in FIG. 3, the computing device 300 can include a locking device 306, a first housing 312, a second housing 314, and a processor 310.

As illustrated in FIG. 3, the computing device 300 can include the first housing 312 and the second housing 314 in an open orientation. When an authorized user may be finished utilizing the computing device 300, the user may rotate the first housing 312 (e.g., as indicated in FIG. 3) towards the second housing 314 about the rotation axis 313 to orient the first housing 312 and the second housing 314 in the closed orientation.

In some examples, in response to the first housing 312 being moved relative to the second housing 314 to the closed orientation, the processor 310 can cause the locking device 306 to be engaged. For example, when a user finishes utilizing the computing device, the user can close the computing device 300. In response to the computing device 300 being closed, the processor 310 can generate a lock signal to cause the locking device 306 to be engaged. As used herein, the term “lock signal” refers to a signal representing information to cause an event to occur. For example, the processor 310 can generate the lock signal to cause the locking device 306 to engage.

In some examples, a user can move the first housing 312 relative to the second housing 314 to the closed orientation. In response, the remote computing device (e.g., not illustrated in FIG. 3) can generate a lock signal and transmit the lock signal to the computing device 300. In response to the computing device 300 receiving the lock signal, the processor 310 can cause the locking device 306 to be engaged. The remote computing device can, in some examples, automatically generate the lock signal and transmit the lock signal to the computing device 300. In some examples, a user can input a command to the remote computing device and in response, the remote computing device can generate the lock signal and transmit the lock signal to the computing device 300.

Computing device unlock codes according to the disclosure can allow for a computing device to be physically locked by a locking device. When an authorized user attempts to access the computing device, display of the unlock code in response to detection of an input by a sensor can provide battery life savings. Such a physical locking system can prevent unauthorized users from attempting to access the computing device and provide a safe and secure security mechanism for the computing device as compared with previous approaches.

FIG. 4 illustrates a block diagram of an example system 430 for computing device unlock codes consistent with the disclosure. In the example of FIG. 4, system 430 includes a processing resource 432 and a non-transitory machine-readable storage medium 434. Although the following descriptions refer to a single processing resource and a single machine-readable storage medium, the descriptions may also apply to a system with multiple processors and multiple machine-readable storage mediums. In such examples, the instructions may be distributed across multiple machine-readable storage mediums and the instructions may be distributed across multiple processors. Put another way, the instructions may be stored across multiple machine-readable storage mediums and executed across multiple processors, such as in a distributed computing environment.

Processing resource 432 may be a central processing unit (CPU), microprocessor, and/or other hardware device suitable for retrieval and execution of instructions stored in machine-readable storage medium 434. In the particular example shown in FIG. 4, processing resource 432 may receive, determine, and send instructions 436, 438, and 440. As an alternative or in addition to retrieving and executing instructions, processing resource 432 may include an electronic circuit comprising a number of electronic components for performing the operations of the instructions in machine-readable storage medium 434. With respect to the executable instruction representations or boxes described and shown herein, it should be understood that part or all of the executable instructions and/or electronic circuits included within one box may be included in a different box shown in the figures or in a different box not shown.

Machine-readable storage medium 434 may be any electronic, magnetic, optical, or other physical storage device that stores executable instructions. Thus, machine-readable storage medium 434 may be, for example, Random Access Memory (RAM), an Electrically-Erasable Programmable Read-Only Memory (EEPROM), a storage drive, an optical disc, and the like. The executable instructions may be “installed” on the system 430 illustrated in FIG. 4. Machine-readable storage medium 434 may be a portable, external or remote storage medium, for example, that allows the system 430 to download the instructions from the portable/external/remote storage medium. In this situation, the executable instructions may be part of an “installation package”.

Detect instructions 436, when executed by a processor such as processing resource 432, may cause system 430 to detect, via a sensor, an input to the computing device 400. The sensor can be, for example, an IR sensor. However, examples of the disclosure are not so limited. For example, the sensor can be a fingerprint scanner, a camera, a wireless transceiver, etc.

Activate instructions 438, when executed by a processor such as processing resource 432, may cause system 430 to activate a display device of the computing device to display an unlock code via a display area of the display device in response to the input. The unlock code can be, for instance, a matrix barcode, a string of alphanumeric characters, a displayed pattern, or combinations thereof, among other types of unlock codes. The unlock code can be displayed for a predetermined amount of time.

Cause instructions 440, when executed by a processor such as processing resource 432, may cause system 430 to cause a locking device of the computing device to disengage from a locked position to an unlocked position in response to an unlock signal being received by the computing device 400 from a remote computing device. For example, the unlock code can be entered into the remote computing device and in response, the remote computing device can generate and transmit an unlock signal to the computing device 400. The computing device 400 can disengage the locking device in response to receiving the unlock signal from the remote computing device.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure.

The figures herein follow a numbering convention in which the first digit corresponds to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2.

Elements illustrated in the various figures herein can be added, exchanged, and/or eliminated so as to provide a plurality of additional examples of the disclosure. In addition, the proportion and the relative scale of the elements provided in the figures are intended to illustrate the examples of the disclosure and should not be taken in a limiting sense. As used herein, a plurality of an element and/or feature can refer to more than one of such elements and/or features.

What is claimed:

1. A computing device, comprising:
a locking device;
a sensor;
a display device including a display area; and
a processor, wherein the processor is to:
detect, via the sensor, an input to the computing device;
activate, in response to the input, the display device to display an unlock code via the display area; and
cause, in response to an unlock signal being received by the computing device from a remote computing device, the locking device to disengage.

2. The computing device of claim 1, wherein:
the computing device includes a first housing and a second housing; and
the display device is located on an external surface of the first housing.

3. The computing device of claim 2, wherein in response to the locking device being disengaged, the first housing is to be moved relative to the second housing to an open orientation.

4. The computing device of claim 2, wherein the processor is to cause the locking device to be engaged in response to the first housing being moved relative to the second housing to a closed orientation.

5. The computing device of claim 2, wherein the processor is to cause the locking device to be engaged in response to:
the first housing being moved relative to the second housing to a closed orientation; and
the processor receiving a lock signal from the remote computing device.

6. The computing device of claim 1, wherein the display device is an electronic paper (e-paper) display device.

7. A non-transitory machine-readable medium including instructions that when executed cause a processor of a computing device to:
detect, via an infrared (IR) sensor, an input to the computing device;
activate, in response to the input, a display device of the computing device to display an unlock code via a display area of the display device for a predetermined amount of time; and
cause, in response to an unlock signal being received by the computing device from a remote computing device, a locking device of the computing device to disengage from a locked position to an unlocked position.

8. The non-transitory medium of claim 7, wherein the unlock signal received by the computing device includes a hash generated by the remote computing device in response to the unlock code being entered into the remote computing device.

9. The non-transitory medium of claim 8, further including instructions that when executed cause the processor to compare the hash received from the remote computing device to a hash table stored in a database.

10. The non-transitory medium of claim 9, further including instructions that when executed cause the processor to cause the locking device of the computing device to disengage in response to the hash received from the remote computing device matching a hash included in the hash table.

11. A computing device, comprising:
a wireless transceiver to detect a remote computing device;
a first housing;
a second housing;
a locking device, wherein the locking device is to lock the first housing and the second housing in a closed orientation when the locking device is in a locked position;
a display device located on an external surface of the first housing and including a display area; and
a processor to:
detect, via the wireless transceiver, when the remote computing device is within a threshold distance to the computing device;
activate, in response to the remote computing device being within the threshold distance, the display device to display an unlock code via the display area; and
cause, in response to an unlock signal being received by the computing device from the remote computing device, the locking device to disengage from the locked position to an unlocked position.

12. The computing device of claim 11, wherein the processor is to change the displayed unlock code in response to the unlock signal not being received after a predetermined amount of time.

13. The computing device of claim 11, wherein the remote computing device corresponds to a user profile of the computing device.

14. The computing device of claim 13, wherein the processor is to cause the computing device to log in to the user profile in response to the unlock signal being received.

15. The computing device of claim 11, wherein the unlock code is a matrix barcode, a string of alphanumeric characters, a displayed pattern, or combinations thereof.
